(19) United States
(12) Patent Application Publication
(10) Pub. No.: US 2017/0066144 A1
(43) Pub. Date: Mar. 9, 2017

(54) Apparatus and Method of Installing Bearings in a One-Piece Handle

(71) Applicant: MENTOR GROUP, L.L.C., Oregon City, OR (US)

(72) Inventor: Ohlrich Michael, Oregon City, OR (US)

(73) Assignee: Benchmade Knife Co., Inc., Oregon City, OR (US)

(21) Appl. No.: 15/309,225

(22) PCT Filed: May 12, 2015
(86) PCT No.: PCT/US15/30273

§ 371 Date: Nov. 7, 2016

Related U.S. Application Data
(60) Provisional application No. 61/994,146, filed on May 16, 2014.

(51) Int. Cl. B26B 1/02; B26B 1/10

(52) U.S. Cl. CPC B26B 1/02; B26B 1/10

(57) ABSTRACT

A folding tool has a monolithic, one-piece handle with an implement rotationally mounted to the handle for rotational movement between a closed, stored position and an open, use position. The handle is adapted for installation of bearings on both sides of the implement following a defined method of installation so that the implement rides on bearings as it is rotated relative to the handle.

### FIELD OF THE INVENTION

This invention relates to tools that have implements foldably attached to a one-piece handle, and especially tools such as knives in which the blade is foldably attached to a one-piece handle.

### BACKGROUND

Unitary, one-piece handles for knives have become increasingly more popular with consumers. There appear to be a variety of reasons for the uptick in interest in knives and other tools with one-piece handles, including aesthetics, strength and functionality. At the same time, some knife makers are using a variety of types of bearings around the pivot shaft where the knife blade is foldably and rotatably attached to the handle. Bearings have obvious functional benefits in such situations since they smooth the rotational movement of the blade from closed to open, and vice versa and they also reduce the amount of force required to rotate the blade.

Conventional folding knives have handles that have opposed sidewalls or handle halves that are attached together with a space between the opposed sidewalls—the blade receiving groove is located in the space between the sidewalls. The blade is rotatably attached to the two handle halves with a pivot shaft that extends through a tang portion of the blade. As the blade rotates between closed and open, open and closed, the blade rotates about the pivot shaft. A variety of spacers and screws are used to attach the handle halves together. In such construction, installing bearings around the pivot shaft is a relatively simple task during assembly of the knife because the bearings can be installed as the handle halves are being connected with the pivot shaft and blade.

However, when the handle is a monolithic unit that has a blade groove in the unitary piece, installation of bearings around the pivot shaft is very difficult because the sidewalls of the handle cannot be separated.

There is a need therefore for apparatus and methods that allow bearings to be installed around the pivot shaft of a knife having a one-piece handle. The present invention defines such apparatus and method. Those of skill in the art will readily recognize that while the invention is enabled with respect to a specific type of knife, the invention is not limited to knives but extends to any tool having a one-piece handle with an implement rotatably attached to the handle.

### BRIEF DESCRIPTION OF THE DRAWINGS

The invention will be better understood and its numerous objects and advantages will be apparent by reference to the following detailed description of the invention when taken in conjunction with the following drawings in which:

FIG. 1 is a perspective view of a type of knife sold by the assignee of the present invention under the trademark BALI-SONG and in which the two handles of the knife are formed in unitary, monolithic pieces and in which the present invention is embodied; in FIG. 1 the blade of the knife is in the closed position between the two handles.

FIG. 2 is a side elevation view of the knife of FIG. 1 and in which the two unitary handles and the blade have been manipulated in order to move the blade into the open position.

FIG. 3 is a perspective and exploded view of one part of one handle of the knife shown in FIG. 1, and more specifically, is an exploded view of the end of one handle to which the blade is attached.

FIG. 4 is a cross sectional view taken along the line 4-4 of FIG. 2.

FIG. 5 is a cross sectional view of an alternative embodiment of an invention according to the present similar to the cross sectional view of FIG. 4 and taken along the same sectional line of a knife in which the alternative embodiment is incorporated as the knife of FIG. 4.

### DETAILED DESCRIPTION OF THE PREFERRED EMBODIMENTS

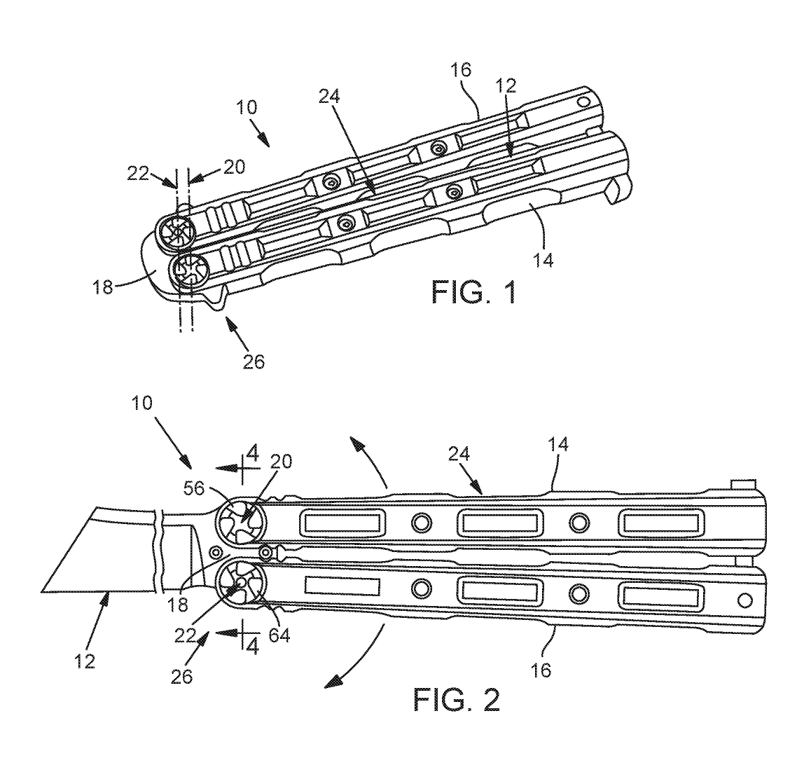

One specific knife that consumers have expressed a strong desire for a one-piece handle is the BALI-SONG knife such as the knife 10 shown in FIG. 1. In FIG. 1 the blade 12 is in the closed position in which the blade is safely stowed between the handle halves. The BALI-SONG knife 10 is a well-known tool in which the single blade 12 is pivotally attached to two separate handle halves 14 and 16. The blade 12 is pivotally attached to each handle half 14 and 16 separately at the tang end 18 of the blade with two separate pivots, labelled 20 and 22 in FIG. 1. Use of such a knife 10 is an art and combat form well known to connoisseurs of these tools.

In the embodiment of knife 10 described herein and shown in the drawings, each of the handle halves 14 and 16 re fabricated as a one piece monolithic unit. In a preferred embodiment the handle halves are machined from aluminum. However, it will be appreciated that there are numerous equivalent methods of forming a unitary handle half and the handles may be formed from a variety of materials such as titanium, G10, etc.

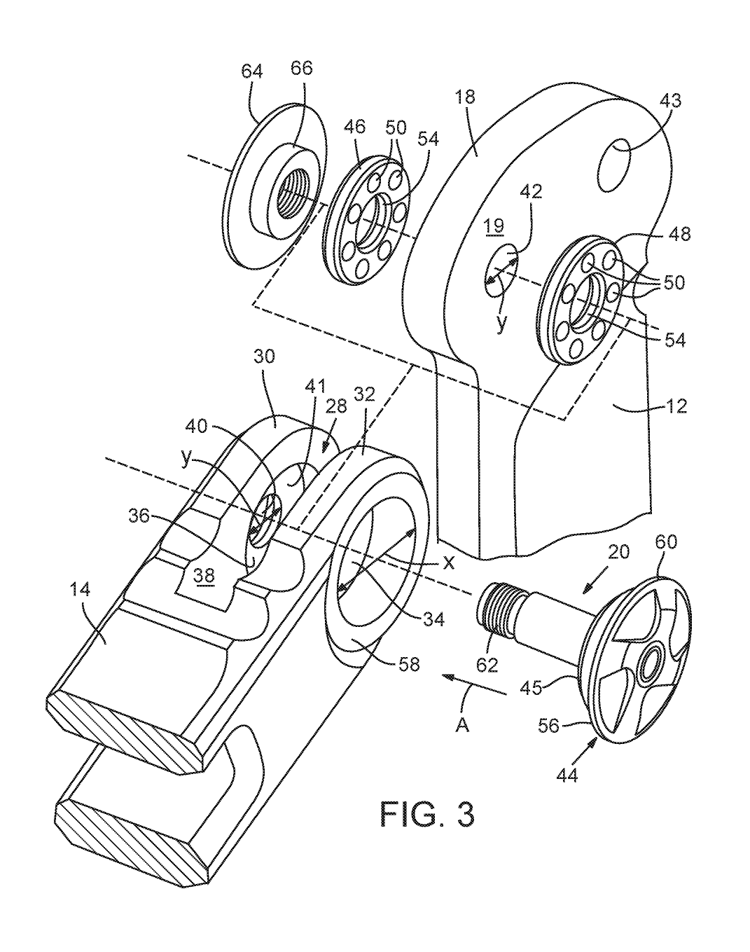

With reference now to FIG. 2 the blade 12 is extended into the extended or working position. Manipulation of the blade 12 and the handle halves 14 and 16 to move the blade/handles between the closed position of FIG. 1 and the open position of FIG. 2 is well-known to those of skill in the art, and as noted above, use of the knife is an art form. Smooth rotational movement of the blade relative to the handles is very important and enhances greatly the manipulation of the knife 10 by users. Said another way, if frictional drag between the pivot shafts that interconnect the blade to the handles is significant, manipulation of the knife according to time honored techniques is impeded. Accordingly, knife makers have always strived to reduce the rotational friction between the blade and the handles.

The apparatus and method of the present invention relates to the dual pivot axes 20 and 22 that attach the blade 12 to the two handle halves 14 and 16. Again, it will be understood that each of the two handle halves 14 and 16 is a monolithic piece. Each of the handle halves includes a longitudinal blade slot 24 into which the blade is received when the knife 10 is in the closed position. In cross section, each of the two handle halves defines a substantially U-shaped member where the blade is received in the U-shaped blade slot 24 when in the closed position. In FIG. 1 the longitudinal slots 24 are facing one another; in FIG. 2 the longitudinal slots 24 face outwardly since the relative positions of the handle halves is reversed when the blade 12 is in the open or extended position.

Reference is now made to FIG. 3, which is a perspective and exploded view of one end of one handle half, in this case handle half 14, illustrating the components of the blade-to-handle pivot in exploded orientation. More specifically, FIG. 3 is a close up perspective and exploded view of the end labelled with reference number 26 in FIG. 2, with the components that comprise pivot axis 20 exploded in the view of FIG. 3.

In the assembled knife 10, the tang end 18 of blade 12 is inserted into the tang slot 28 in handle half 14 and is pivotally attached thereto with the components that define the pivot axis 20. The tang slot 28 is defined by two sides of handle half 14, one on either side of tang slot 28 and labelled with reference numbers 30 and 32 in FIG. 3. A bore 34 having a diameter X is formed through side 32. A blind counter bore 36 is formed in the interior surface 38 of side 30; blind counter bore 36 is axially aligned with bore 34 and has a diameter X identical to of closely similar to the diameter X of bore 34. It will be understood by those of skill in the art that the diameter of the bores and other structures identified herein as being identical or the same are very close to being the same size and are within normal manufacturing tolerances, but seldom are precisely identical. A central through-bore 40 having a diameter Y is formed through the axial center of blind counter bore 36 such that the center of through-bore 40 is axially aligned with the axial center of bore 34. The diameter Y is less than the diameter X to thereby define a seat 41 around through-bore 40 and created by the counter bore 36. The term through-bore as used herein refers to a bore that penetrates entirely through the pertinent material in which the bore is formed.

A pivot shaft bore 42 having a diameter Y (or nominally slightly larger than Y) is formed through tang end 18 of blade 12. Because there are two handle halves 14 and 16, a second pivot shaft bore 43 is formed through tang end 18 for receiving the other pivot axis associated with handle half 16. The diameter of pivot shaft bore 43 also is Y.

The pivot axis 20 is defined by a pivot shaft 44, and pair of cartridge bearings 46 and 48 and a retainer nut 64. Each of the cartridge bearings 46 and 48 is identical and are cartridge type bearings in which plural balls 50 are retained between inner and outer races. The bearings 46 and 48 are commercially available on the market. The outer diameter of each cartridge bearing 46, 48 is X (or nominally slightly smaller than X) so that a bearing, in the case of FIG. 3, cartridge bearing 46 may be inserted through bore 34 of side 32 in the direction of arrow A in FIG. 3, and seated in the seat 41 in side 30, which as detailed above is formed by counter bore 36. The thickness of cartridge bearing 46 is such that when the bearing is seated in seat 41 the exposed balls 50 are positioned such that when tang 18 of blade 12 is inserted into the tang slot 28 the balls 50 make contact with the side surface of the tang 18 (there are 7 balls 50 spaced around the periphery of the bearings 46, 48 shown in FIG. 3—it will be understood that these specific bearings are exemplary only). With the bearing 46 seated in seat 41, the opening 54 through the center of the bearing is axially aligned with the axial center of through-bore 40.

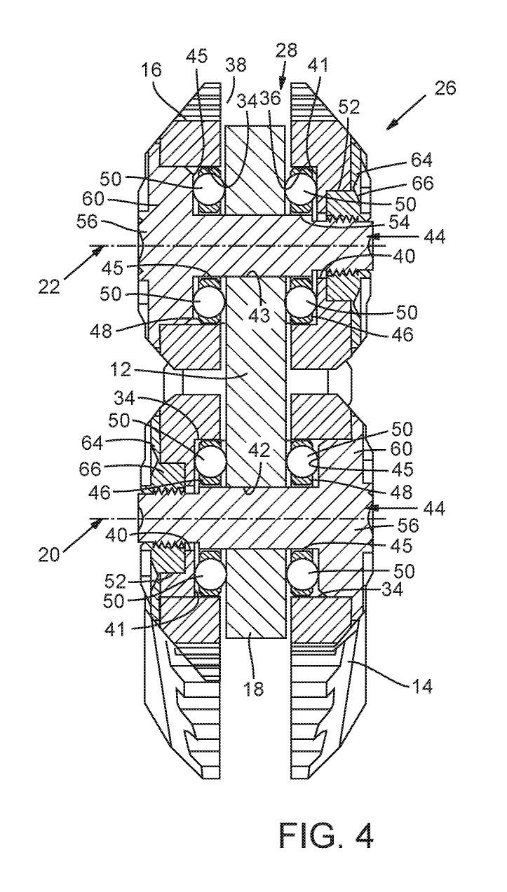

The next step in assembly of the pivot axis 20 is to slide the tang 18 of blade 12 into tang slot 28 between sides 30 and 32 until the pivot shaft bore 42 is axially aligned with the through-bore 40. The second cartridge bearing 48 is then inserted into bore 34 in side 32 of handle half 14 in the direction of arrow A until the balls 50 of bearing 48 rest on the surface 19 of tang 18 of the blade and such that opening 54 is axially aligned with through-bore 40. Pivot pin 44 is then inserted through the aligned bores and openings in the direction of arrow A—that is, in sequential order, the distal end 62 of pivot pin 44 is inserted through bore 34 in side 32 and through opening 54 in bearing 48, through pivot shaft bore 42 in tang 18 of blade 12, and through opening 54 in bearing 46 and through through-bore 40 in side 30. Pivot pin 44 has a bearing-contacting surface or seat 45 that in the assembled knife 10 bears against the balls 50 of cartridge bearing 48—this is best seen in the sectional view of FIG. 4. The proximate end 56 of pivot pin 44 defines a larger diameter flange 60 that is received in a seat 58 formed on the outer surface of side 32 and around bore 34. The distal end 62 of the pivot pin 44 extends through the entire assembly and a retainer nut 64 is attached to the distal end 62, for example, with a threaded attachment or other attachment that allowed for compression of the components of the pivot axis. Retainer nut 64 includes a cylindrical and inwardly-projecting boss 66 that fits into a cylindrical recess 52 in the outer side of side 30 (not visible in FIG. 3 but see FIG. 4). Boss 66 has a threaded bore formed therethrough that is adapted for receiving the threaded end of pivot pin 44. As such, when retainer nut 64 is threaded onto pivot pin 44 as shown in FIG. 4 the boss 66 the nut may be tightened to secure the assembly.

The same process is repeated with the components of pivot axis 22, which is identical to the pivot axis 20 just described except as noted below:

FIG. 4 is a cross sectional view taken along the line 4-4 of FIG. 2. It will be appreciated that in the orientation of the components of pivot axis 20 are the inverse of the components of pivot axis 22, although in practice these components may be oriented in the same manner if desired.

When assembled as illustrated in FIG. 4, the tang 18 of blade 12 rides on and is supported by the exposed balls 50 of the bearings 46, 48 and rotation of the blade about the pivot axes 20, 22 is very smooth and easy. More specifically, the retainer nuts 64 are tightened to the pivot pins 44 such that the exposed balls 50 of the cartridge bearings 46 and 48 are compressed between the seats 41 (of the sides 30, 32 of the handle halves) and the seats 45 of the pivot pins 44. The retainer nuts 64 draw the pivot pin toward the center of the structure creating a compressive pre-load on the bearings, blade and handles.

The components of pivot axes 20 and 22 and the structural features that they are assembled with in the handle halves 12 and 14 allow bearings to be easily installed into a monolithic handle.

In the embodiment of knife 10 shown in FIGS. 1 through 4 the material that is used to define the handle defines one of the surfaces on which the balls 50 of bearings 46 make contact. More specifically, the balls 50 of cartridge bearing 46 make direct contact with the material of handle 14 at seat 41, as best shown in FIGS. 3 and 4. In some instances, the material that is used to fabricate the handles 14 and 16 may not define adequate surfaces on which the balls make contact. For example, if the handle material is relatively soft the balls can wear on the seat more rapidly than desired, which could negatively affect performance of the blade over time.

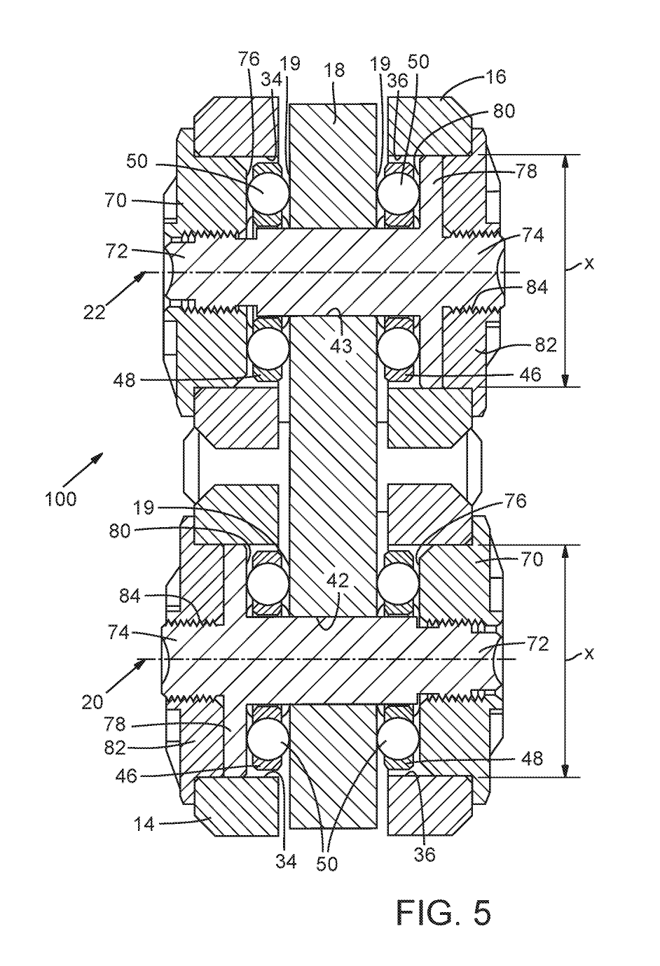

This wearing-in phenomena may be alleviated or eliminated in several ways. A first method is to deposit a relatively harder surface in seat 41 on which balls 50 rotate—for example, with a deposited coating or an insert such as a washer that defines a harder surface. Another solution is illustrated in FIG. 5, which is a cross sectional view of a knife 100 that is analogous to the view of knife 10 shown in FIG. 4, except illustrating an alternative in which pivot axes 20 and 22 are defined by an alternative structure to those shown in FIG. 4. More specifically still, in FIG. 5 the pivot axes 20 and 22 are defined by a three component pieces whereas the pivot axes 20 and 22 shown in FIG. 4 have two analogous components, namely, the pivot pin 44 and the retainer nut 64.

In FIG. 5 the bores 34 and 36 through the sides 30 and 32, respectively, are both through-bores that have a diameter X. A retainer nut 70 threads onto the distal end 72 of pivot pin 74 and the inner-facing surface of nut 70 defines a bearing surface that bears against balls 50 of cartridge bearing 48 on the outer side of the bearing and defines the outer seat for the bearing (the surface 19 of tang 18 continues to define the seat against which balls 50 bear on the opposite side of the bearing). The pivot pin 74 includes a radial flange 78 that has an outer diameter X and which is received in bore 34 and the inner-facing surface 80 of which bears against balls of cartridge bearing 46. The surface 19 of tang 18 defines the bearing surface against which balls 50 of cartridge bearing 46 ride on the opposite side thereof. A second retainer nut 82 threads onto the threaded end 84 of pivot pin 74 and the second nut 82 bears against the radial flange 78. The knife lOs shown in FIG. 5 is assembled in a manner similar to the assembly of knife 10 described above except that the second retainer nut 82 is used to adjust the tightness of the components of the pivots 20 and 22.

While the present invention has been described in terms of a preferred embodiment, it will be appreciated by one of ordinary skill that the spirit and scope of the invention is not limited to those embodiments, but extend to the various modifications and equivalents as defined in the appended claims.

1-20. (canceled)

21. A method of installing an implement in a tool having a monolithic, one-piece handle with opposed first and second handle halves with the implement rotatably retained between the handle halves in an implement slot, comprising the steps of:
a) forming a first bore in the first handle half, the first bore having a diameter X;
b) forming a second bore in the second handle half, the second bore axially aligned with the first bore and having a diameter X;
c) installing a first bearing in the second bore;
d) installing an implement in the implement slot so that a pivot bore in the implement is axially aligned with the first bore and the second bore;
e) installing a second bearing in the first bore;
f) inserting a pivot pin through the first bore, the pivot bore, and the second bore; and
g) securing the pivot pin.

22. The method according to claim 21 wherein the second bore is a counter bore and including the step of forming a through-bore in the second handle half, the through-bore axially aligned with the first bore and the second bore and having a diameter Y, wherein said second bore thereby defines a seat having a diameter X.

23. The method according to claim 22 wherein the step of securing the pivot pin includes the step of compressing the first and second bearings against the implement so that the implement rides on the bearings as it rotates relative to the handle.

24. The method according to claim 23 wherein the step of securing the pivot pin further includes the step of attaching a retaining nut to the pivot pin.

25. The method according to claim 24 wherein Y is less than X.

26. The method according to claim 24 in which the first and second bearings are cartridge bearings having a diameter X.

27. The method according to claim 26 in which the first cartridge bearing bears on the implement on a first side of said first cartridge bearing and on the seat on a second side of said first cartridge bearing, and in which the second cartridge bearing bears on the implement on a first side of said second cartridge bearing and on the pivot pin on a second side of said second cartridge bearing.

28. The method according to claim 21 wherein the second bore is a through-bore.

29. The method according to claim 28 including the step of attaching a first retaining nut to a distal end of said pivot pin, said first retaining nut having a diameter X and defining a first bearing surface.

30. The method according to claim 29 in which the pivot pin further defines a radial flange that has a diameter X and which is received in the first bore to define a second bearing surface.

31. The method according to claim 30 in which the first and second bearings are cartridge bearings having a diameter X and in which the first cartridge bearing bears on the implement on a first side of said first cartridge bearing and on the first bearing surface on a second side of said first cartridge bearing, and in which the second cartridge bearing bears on the implement on a first side of said second cartridge bearing and on the radial flange on a second side of said second cartridge bearing.

32. A tool having a monolithic, one piece handle with opposed first and second handle halves with an implement slot therebetween, comprising:
an implement rotatably retained between the handle halves at a tang portion of said implement; and
wherein said monolithic handle is defined by:
a first bore in the first handle half;
a second bore in the second handle half that is axially aligned with the first bore;
a first cartridge bearing in the second bore, said first cartridge bearing having a central opening that is axially aligned with the first bore;
a second cartridge bearing in the first bore, said second cartridge bearing having a central opening that is axially aligned with the first bore;
the tang of said implement in the implement slot with a pivot bore in said tang axially aligned with the first bore;
a first bearing surface in the second bore outwardly of said first cartridge bearing;
a second bearing surface in the first bore outwardly of said second cartridge bearing;
a pivot pin extending through the first bore, the central opening in the second cartridge bearing, the pivot bore in said tang, the central opening in the first cartridge bearing, and the second bore; and wherein
the tang has opposed sides and the surface of the tang on both of said opposed sides define bearing surfaces.

33. The tool according to claim 32 in which the diameter of the first and second bores in the respective first and second handle halves is X.

34. The tool according to claim 33 in which a first retaining nut attached to a distal end of said pivot pin defines the first bearing surface and said pivot pin further defines a radial flange that defines the second bearing surface.

35. The tool according to claim 34 including a second retaining nut attached to a proximate end of said pivot pin.

36. The tool according to claim 32 in which the diameter of the first bore in the first handle half is X and the second bore in the second handle half is defined by a through-bore having a diameter Y that is less than X and a counter bore having a diameter X so that said counter bore defines the first bearing surface.

37. The tool according to claim 32 comprising a BALI-SONG knife.

38. A method of installing an implement in a tool having a one-piece handle with opposed first and second handle halves with the implement rotatably retained between the handle halves in an implement slot, comprising the steps of:
a) forming a first bore in the first handle half, the first bore having a diameter X;
b) forming a counter bore in the second handle half, the counter bore axially aligned with the first bore and having a diameter X;
c) forming a through-bore in the second handle half, the through-bore having a diameter Y that is less than X and the through-bore axially aligned with the counter bore to define a bearing seat;
d) installing a first cartridge bearing in the bearing seat so that a first side of the first cartridge bearing bears on the bearing seat;
d) installing an implement in the implement slot with a pivot bore in the implement axially aligned with the first bore and so that a second side of the cartridge bearing bears on the implement;
e) installing a second cartridge bearing in the first bore so that so that a first side of the second cartridge bearing bears on the implement;
f) inserting a pivot pin through the first bore, the pivot bore, and the second bore, wherein the second side of the second cartridge bearing bears on the pivot pin.

39. The method according to claim 38 including the step of attaching a retaining nut to a distal end of the pivot pin and adjusting the retaining nut to adjust the rotation of the implement.

40. The method according to claim 39 in which the tool comprises a BALI-SONG knife.
